(19) United States
(12) Patent Application Publication
(10) Pub. No.: US 2013/0107160 A1
(43) Pub. Date: May 2, 2013

(54) TRANSPARENT DISPLAY APPARATUS

(71) Applicants: Daewon KIM, Dongducheon-si (KR); Kwang-Hyun KIM, Gunpo-si (KR); Sang-Jae KIM, Seongnam-si (KR); Ji-Hoon KIM, Hwaseong-si (KR); Taeho KIM, Asan-si (KR); Seungbeom PARK, Seoul (KR); Beong-hun BEON, Cheonan-si (KR); NaYoung SHIN, Seoul (KR); Seunghee LEE, Seoul (KR)

(72) Inventors: Daewon KIM, Dongducheon-si (KR); Kwang-Hyun KIM, Gunpo-si (KR); Sang-Jae KIM, Seongnam-si (KR); Ji-Hoon KIM, Hwaseong-si (KR); Taeho KIM, Asan-si (KR); Seungbeom PARK, Seoul (KR); Beong-hun BEON, Cheonan-si (KR); NaYoung SHIN, Seoul (KR); Seunghee LEE, Seoul (KR)

(73) Assignee: SAMSUNG ELECTRONICS CO., LTD., Suwon-si (KR)

(21) Appl. No.: 13/433,670

(22) Filed: Mar. 29, 2012

(30) Foreign Application Priority Data
Oct. 26, 2011 (KR) 10-2011-0110135

(51) Int. Cl. G02F 1/13357; H01J 9/00

(52) U.S. Cl. 349/58; 445/24

(57) ABSTRACT

A transparent display apparatus includes a housing including an opening portion which extends through a surface at a viewing side thereof, the housing accommodating an object, a liquid crystal display panel at a front of the object and adjacent to the opening portion, a first polarizing plate between the opening portion and the liquid crystal display panel, a second polarizing plate at a rear of the object, a first reflective plate at a rear of the second polarizing plate a light source adjacent to the object.

This application claims priority to Korean Patent Application No. 10-2011-0110135 filed on Oct. 26, 2011, and all the benefits accruing therefrom under 35 U.S.C. §119, the contents of which are herein incorporated by reference in its entirety.

### BACKGROUND OF THE INVENTION

1. Field of the Invention

The invention relates to a transparent display apparatus. More particularly, the invention relates to a transparent display apparatus capable of transmitting a light.

2. Description of the Related Art

A transparent display apparatus is widely applied to various fields, such as advertisement, smart window, etc., as a next generation display. The transparent display apparatus allows users to perceive a displayed object facing a liquid crystal display panel by removing an opaque reflective plate, optical sheets, and a light source from a display apparatus or by changing a position of the opaque reflective plate, the optical sheets, and the light source in the display apparatus, and displays an image.

The transparent display apparatus includes polarizing plates respectively disposed on front and rear surfaces of the liquid crystal display panel to control a transmittance of light passing therethrough. However, the transmittance of the light passing through the polarizing plates and the liquid crystal display panel is lowered due to the polarizing plates.

In addition, the polarizing plates transmit the light when liquid crystal molecules in the liquid crystal display panel are driven, but the polarizing plates are in an opaque state when the liquid crystal molecules are not driven. As a result, a power source is required to be continuously applied to the transparent display apparatus in order to display the displayed object, thereby enhancing power consumption in the transparent display apparatus and lowering durability of the transparent display apparatus. In addition, the transparent display apparatus malfunctions when the liquid crystal display panel is mis-operated.

### BRIEF SUMMARY OF THE INVENTION

Exemplary embodiments of the invention provide a transparent display apparatus capable of improving a light transmittance and a visibility of a displayed object.

According to the exemplary embodiments, a transparent display apparatus includes a housing, a liquid crystal display panel, a first polarizing plate, a second polarizing plate, a first reflective plate and a light source.

The housing includes an opening portion which extends through a surface thereof to accommodate an object, and the liquid crystal display panel is disposed at a front of the object and adjacent to the opening portion. The first polarizing plate is disposed between the opening portion and the liquid crystal display panel, and the second polarizing plate is disposed at a rear of the object. The first reflective plate is disposed at a rear of the second polarizing plate and the light source is disposed adjacent to the object.

The first polarizing plate has a first polarizing axis, and the second polarizing plate has a second polarizing axis substantially perpendicular to the first polarizing axis.

The housing further includes a sidewall portion which extends from the surface including the opening portion to define a display space in which the object is displayed.

The housing has a polygonal shape or a semi-circular shape in a cross-sectional view substantially perpendicular to the sidewall portion.

The transparent display apparatus further includes a third polarizing plate and a second reflective plate, and the sidewall portion includes a plurality of sidewalls. The third polarizing plate and the second reflective plate are disposed on at least one of the sidewalls.

The transparent display apparatus further includes a backlight unit disposed between the liquid crystal display panel and the object. The backlight unit includes an auxiliary light source disposed at an edge of the liquid crystal display panel to emit a light, a transparent light guide plate guiding the light emitted from the auxiliary light source to the liquid crystal display panel and a third polarizing plate disposed between the auxiliary light source and the transparent light guide plate.

The third polarizing plate has a polarizing plate substantially perpendicular to a polarizing plate of the first polarizing plate.

The transparent display apparatus further includes a backlight unit disposed between the second polarizing plate and the first reflective plate. The backlight unit includes an auxiliary light source disposed at an edge of the second polarizing plate to emit a light and a transparent light guide plate guiding the light emitted from the auxiliary light source to the second polarizing plate.

The second polarizing plate makes contact with the first reflective plate.

The transparent display apparatus further includes optical sheets disposed between the second polarizing plate and the first reflective plate.

The optical sheets include at least one of a brightness enhancement film, a dual brightness enhancement film, a diffusion sheet, a prism sheet or a protective sheet.

The transparent display apparatus further includes a transparent retardation film disposed between the first polarizing plate and the liquid crystal display panel.

According to the above, the object is disposed between the first and second polarizing plates. Thus, although the power source is not applied, the object is continuously perceived in the transparent display apparatus, thereby effectively displaying the object. In addition, the display of the object may be continuously maintained even though the liquid crystal display panel is malfunctioned.

### BRIEF DESCRIPTION OF THE DRAWINGS

The above and other advantages of the invention will become readily apparent by reference to the following detailed description when considered in conjunction with the accompanying drawings wherein:

FIG. 1 is an exploded perspective view showing an exemplary embodiment of a transparent display apparatus according to the invention;

FIG. 2 is a plan cross-sectional view showing the transparent display apparatus according to the invention;

FIG. 3 is a view showing another exemplary embodiment of a transparent display apparatus according to the invention, taken along line A-A′ in FIG. 1;

FIG. 4 is a plan cross-sectional view showing another exemplary embodiment of a transparent display apparatus according to the invention;

FIG. 5 is a plan cross-sectional view showing still another exemplary embodiment of a transparent display apparatus according to the invention;

FIG. 6 is a plan cross-sectional view showing still another exemplary embodiment of a transparent display apparatus according to the invention;

FIG. 7 is a plan cross-sectional view showing still another exemplary embodiment of a transparent display apparatus according to the invention;

FIG. 8 is a plan cross-sectional view showing still another exemplary embodiment of a transparent display apparatus according to the invention;

FIG. 9 is an exploded perspective view showing a conventional transparent display apparatus;

FIG. 10 is a view showing an exemplary embodiment of a displayed object and a displayed image by a transparent display apparatus according to the invention, and by a conventional transparent display apparatus; and

FIG. 11 is a view showing states when no power source is applied to an exemplary embodiment of a transparent display apparatus according to the invention, and to a conventional transparent display apparatus.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” or “connected to” another element or layer, it can be directly on or connected or coupled to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be explained in detail with reference to the accompanying drawings.

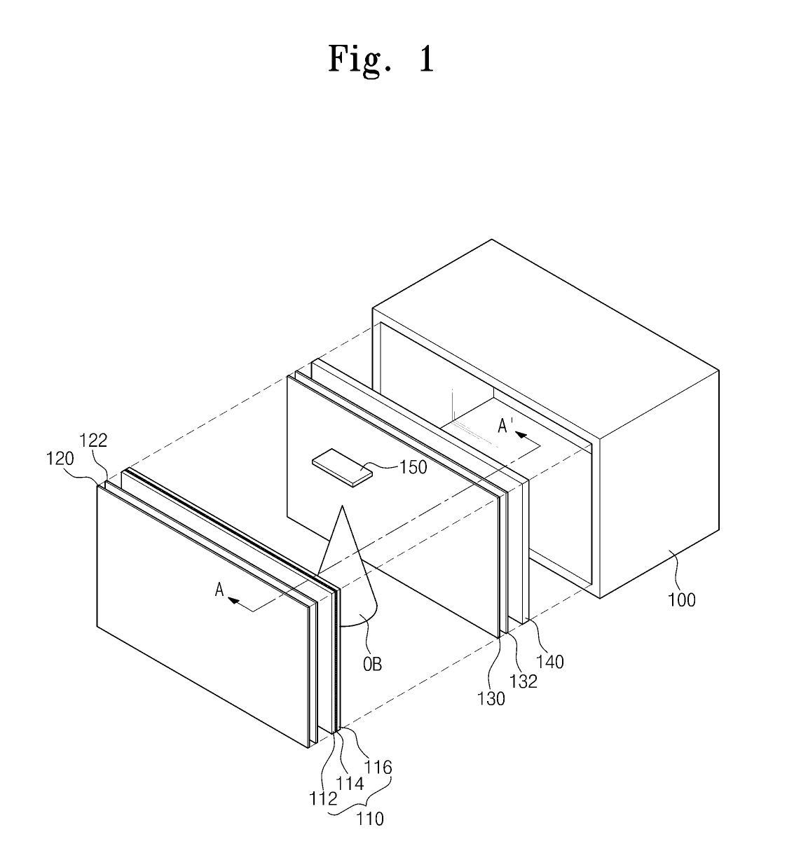

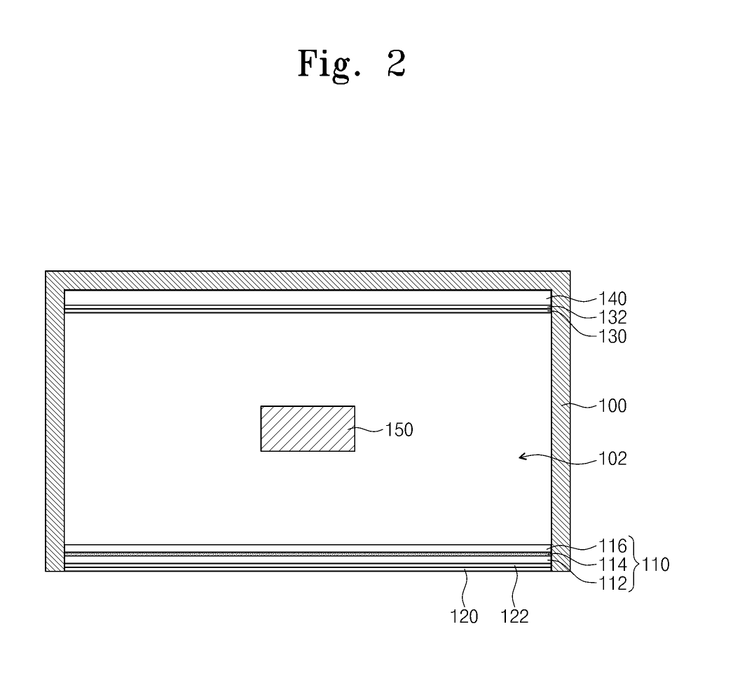

FIG. 1 is an exploded perspective view showing an exemplary embodiment of a transparent display apparatus according to the invention and FIG. 2 is a plan cross-sectional view showing the transparent display apparatus according to the invention.

Referring to FIG. 1, a transparent display apparatus includes a housing 100, a liquid crystal display panel 110, a first polarizing plate 120, a second polarizing plate 130, a reflective plate 140 and a light source 150. The transparent display apparatus may display a displayed object (hereinafter, referred to as object) OB and substantially simultaneously display an explanation about the object OB. The term of “transparent” may mean “semi-transparent” and “fully transparent.”

The housing 100 defines a display space 102 in which the object OB is accommodated. The housing 100 includes an opening portion where a surface or side thereof is absent and at least one sidewall extended from the absent surface side, which defines the opening portion, to surround the object OB. In addition, the housing 100 may further include an upper surface and a lower surface, which are substantially vertical (e.g., perpendicular) to the surface including the opening portion and the sidewall. In an exemplary embodiment, the housing 100 includes a first sidewall which faces the opening portion, and second sidewalls which extend directly from the first sidewall toward the side of the opening portion. Although not shown in FIGS. 1 and 2, a transparent plate including a transparent material, e.g., glass, may be disposed at the opening portion of the housing 100.

Referring to FIG. 2, the housing 100 has a rectangular shape when view in a plan view substantially parallel to the upper surface of the housing 100.

The liquid crystal display panel 110 is disposed adjacent to the opening portion of the housing 100. The liquid crystal display panel 110 has a rectangular plate shape in the plan view. The liquid crystal display panel 110 includes a first substrate 112, a second substrate 116 facing the first substrate 112, and a liquid crystal layer 114 disposed between the first substrate 112 and the second substrate 116. The first and second substrates 112 and 116 may be a transparent substrate.

The first substrate 112 includes a plurality of pixel electrodes (not shown), and a plurality of thin film transistors (not shown) connected to the pixel electrodes in a one-to-one correspondence. Each of the thin film transistors switches a driving signal and applies the driving signal to a corresponding pixel electrode of the pixel electrodes. The second substrate 116 includes a common electrode (not shown) that forms an electric field in cooperation with the pixel electrodes to control an arrangement of liquid crystal molecules in the liquid crystal layer 114. The liquid crystal molecules are rearranged according to the electric field and control a transmittance of a light passing therethrough, thereby displaying a desired image.

As shown in FIG. 2, the first polarizing plate 120 is disposed between the opening portion of the housing 100 and the liquid crystal display panel 110. The first polarizing plate 120 has a first polarizing axis and transmits the light provided from the light source 150, which is vibrated in the first polarizing axis.

According to the exemplary embodiment, the transparent display apparatus may further include a retardation film 122 disposed between the first polarizing plate 120 and the liquid crystal display panel 110. The retardation film 122 compensates for birefringence caused by the liquid crystal molecules, thereby improving performance of the transparent display apparatus.

The second polarizing plate 130 is disposed adjacent to the sidewall facing the opening portion of the housing 100. The second polarizing plate 130 has a second polarizing axis different from the first polarizing axis of the first polarizing plate 120. In one exemplary embodiment, for instance, the first and second polarizing axes may be perpendicular to each other. The second polarizing plate 130 transmits the light provided from the light source 150, which is vibrated in the second polarizing axis. As an example, the second polarizing plate 130 may be a polarizing film or a wire grid polarizing plate.

The reflective plate 140 is disposed between the sidewall of the housing 100 facing the opening portion and the second polarizing plate 130. In the exemplary embodiment, the second polarizing plate 130 may be attached to the reflective plate 140. According to embodiments, optical sheets 132 may be disposed between the reflective plate 140 and the second polarizing plate 130. Various films or sheets, such as a brightness enhancement film (“BEF”), a dual brightness enhancement film (“DBEF”), a diffusion sheet, a prism sheet, a protective sheet, etc., may be used as the optical sheets 132.

In the exemplary embodiment, the display space 102 is defined by the liquid crystal display panel 110, the second polarizing plate 130 and the sidewalls of the housing 100. Particularly, the object OB is disposed between the liquid crystal display panel 110 and the second polarizing plate 130.

The light source 150 is positioned at an upper portion of the display space 102. The light source 150 emits a non-polarized light.

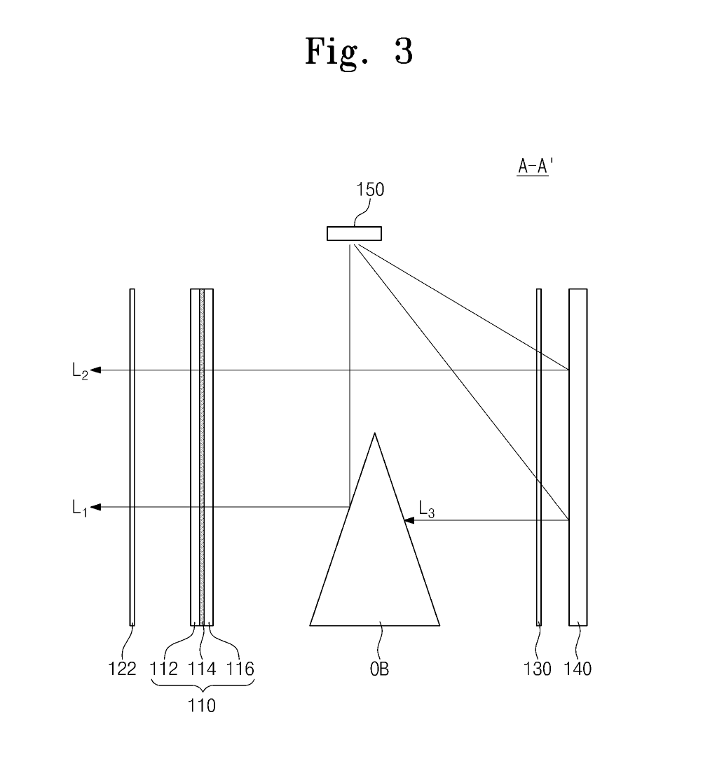

Hereinafter, an optical path of the light emitted from the light source 150 will be described. FIG. 3 is a view showing another exemplary embodiment of a transparent display apparatus according to the invention taken along line A-A′ shown in FIG. 1. In addition, for the convenience of explanation, the retardation film 122 and the optical sheets 132 have been omitted from FIG. 3.

Referring to FIG. 3, a first portion L₁ of the light emitted from the light source 150 is directly provided to the object OB and reflected from or absorbed by the object OB. The reflected first portion L₁ of the light passes through the liquid crystal display panel 110 and the first polarizing plate 120.

A second portion L₂ of the light emitted from the light source 150 travels to the second polarizing plate 130 and is reflected by the reflective plate 140 to be provided to the display space 102. Since the second portion L₂ of the light passes through the second polarizing plate 130, the light provided to the display space 102 is vibrated in the second polarizing axis. A third portion L₃ of the light emitted from the light source 150 is blocked by the object OB after being reflected by the reflective plate 140, and thus the third portion L₃ does not travel to the liquid crystal display panel 110 and the first polarizing plate 120. Thus, the light vibrated in the second polarizing axis is not provided to the first polarizing plate 120, and thus the object OB may be always displayed.

In addition, since the second portion L₂ is vibrated in the second polarizing axis, the second portion L₂ does not pass through the first polarizing plate 120 and only the light vibrated in the first polarizing axis passes through the first polarizing plate 120 to be displayed as the image.

As described above, the second polarizing plate 130 is disposed between the object OB and the reflective plate 140 and the object OB is disposed between the second polarizing plate 130 and the liquid crystal display panel 110, so the object OB may be effectively displayed. In addition, although the power source in not applied to the liquid crystal display panel 110 or the liquid crystal display panel 110 is malfunctioned, the object OB may be effectively displayed.

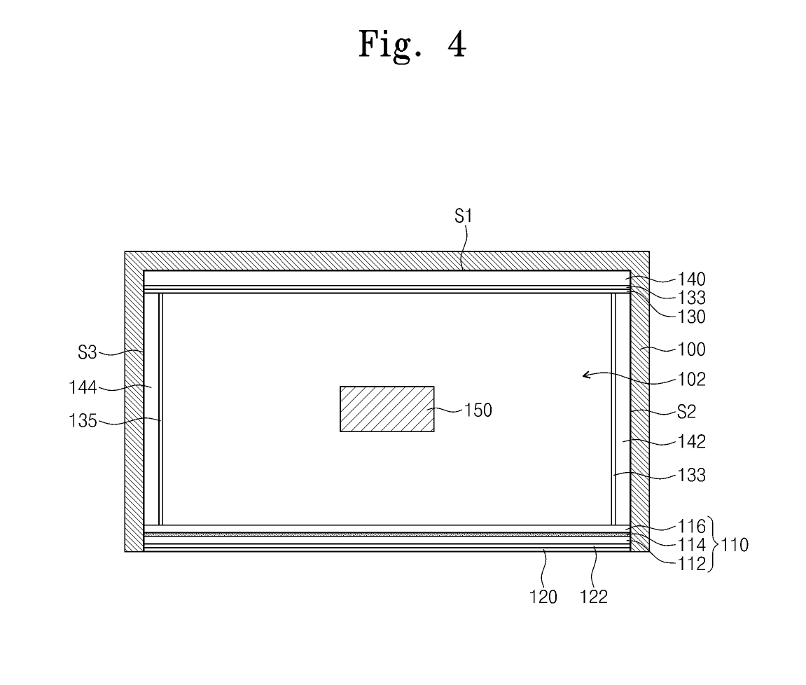

FIG. 4 is a plan cross-sectional view showing another exemplary embodiment of a transparent display apparatus according to the invention. In FIG. 4, the same reference numerals denote the same elements in FIGS. 1 and 2, and thus detailed descriptions of the same elements will be omitted.

Referring to FIG. 4, a transparent display apparatus includes a housing 100, a liquid crystal display panel 110, a first polarizing plate 120, a second polarizing plate 130, a third polarizing plate 133, a fourth polarizing plate 134, a first reflective plate 140, a second reflective plate 142, a third reflective plate 144, and a light source 150.

The housing 100 includes an opening portion where a surface or side thereof is absent and at least one sidewall extended from the absent surface side, which defines the opening portion, to surround the object OB. In the exemplary embodiment, the housing 100 has a rectangular shape when viewed in a plan cross-sectional view substantially parallel to the upper surface of the housing 100. In this view, the housing 100 includes three sidewalls. For the convenience of explanation, the three sidewalls will be referred to as a first sidewall S1, a second sidewall S2 and a third sidewall S3, respectively. The first sidewall S1 faces the opening portion, and the second and third sidewalls S2 and S3 are extended from respective opposing ends of the first sidewall S1 in a direction substantially vertical (e.g., perpendicular) to the first sidewall S1.

The first polarizing plate 120 and the liquid crystal display panel 110 are disposed adjacent to the opening portion and the object OB is disposed at a rear of the liquid crystal display panel 110 (e.g., towards the first sidewall S1). The second polarizing plate 130 and the first reflective plate 140 are disposed on and closest to the first sidewall S1, the third polarizing plate 133 and the second reflective plate 142 are disposed on the second sidewall S2, and the fourth polarizing plate 134 and the third reflective plate 144 are disposed on the third sidewall S3.

The first polarizing plate 120 has a first polarizing axis and the second to fourth polarizing plates 130, 133 and 134 have a second polarizing axis different from the first polarizing axis. The first and second polarizing axes may be substantially perpendicular to each other.

As described above, the second, third, and fourth polarizing plates 130, 133 and 134 are respectively disposed on the first, second, and third sidewalls S1, S2, and S3 and the first, second, and third reflective plates 140, 142 and 144 are respectively disposed on the first, second, and third sidewalls S1, S2, and S3. Accordingly, the image displayed on the liquid crystal display panel 110 and the object OB displayed through the liquid crystal display panel 110 may be effectively displayed in the upper and lower and the left and right directions.

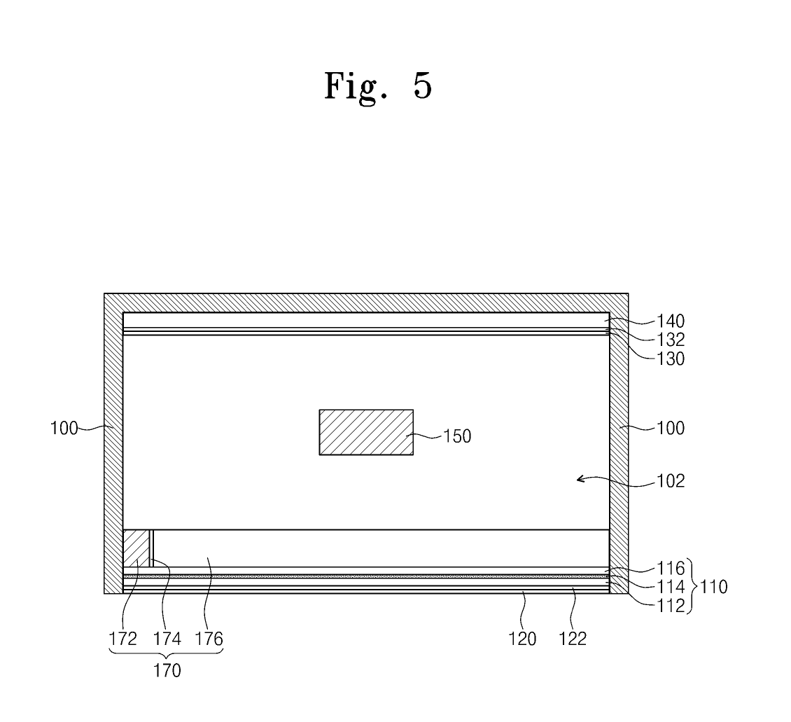

FIG. 5 is a plan cross-sectional view showing still another exemplary embodiment of a transparent display apparatus according to the invention. In FIG. 5, the same reference numerals denote the same elements in FIGS. 1 and 2, and thus detailed descriptions of the same elements will be omitted.

Referring to FIG. 5, a transparent display apparatus includes a housing 100, a liquid crystal display panel 110, a first polarizing plate 120, a second polarizing plate 130, a reflective plate 140, a light source 150 and a backlight unit 170.

The housing 100 includes an opening portion, and the first polarizing plate 120 and the liquid crystal display panel 110 are disposed adjacent to the opening portion. The object OB is disposed at a rear of the liquid crystal display panel 110. The second polarizing plate 130 and the reflective plate 140 are disposed adjacent to a rear sidewall of the housing 100, which faces the opening portion. The light source 150 is disposed above the object OB.

According to the exemplary embodiment, the backlight unit 170 may be disposed between the liquid crystal display panel 110 and the object OB.

The backlight unit 170 includes an auxiliary light source 172 generating and providing a light to the liquid crystal display panel 110, a transparent light guide plate 176 guiding the light emitted from the auxiliary light source 172, and a third polarizing plate 174 disposed between the auxiliary light source 172 and the light guide plate 176 while being attached to a surface of the auxiliary light source 172. The third polarizing plate 174 has a polarizing axis substantially vertical (e.g., perpendicular) to a polarizing axis of the first polarizing plate 120.

When a separate power source is applied to the backlight unit 170, the transparent display apparatus may be utilized according to specific purposes. In one embodiment, for instance, image information displayed on the liquid crystal display panel 110 may be spotlighted by using the backlight unit 170, or the object OB may be spotlighted by not using the backlight unit 170.

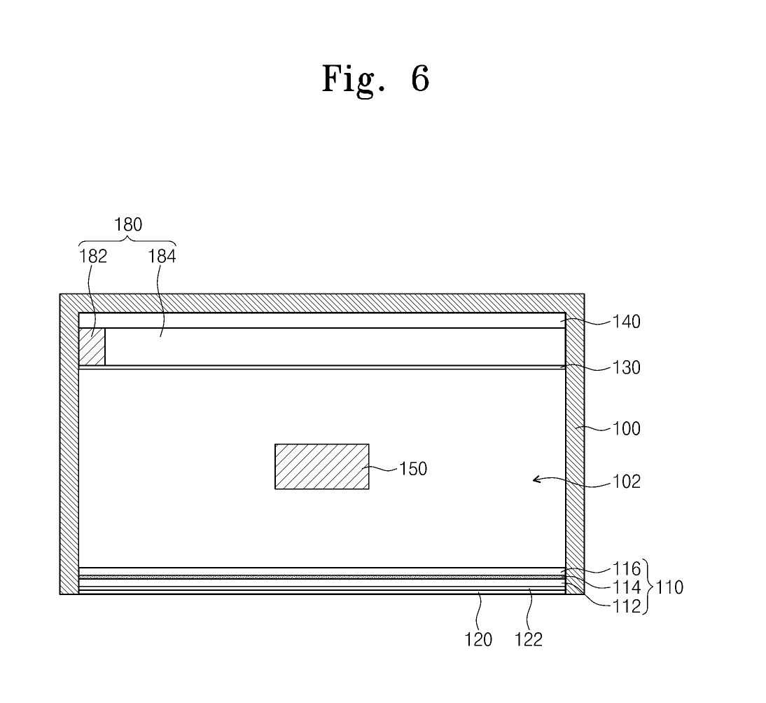

FIG. 6 is a plan cross-sectional view showing still another exemplary embodiment of a transparent display apparatus according to the invention. In FIG. 6, the same reference numerals denote the same elements in FIGS. 1 and 2, and thus detailed descriptions of the same elements will be omitted.

Referring to FIG. 6, a transparent display apparatus includes a housing 100, a liquid crystal display panel 110, a first polarizing plate 120, a second polarizing plate 130, a reflective plate 140, a light source and a backlight unit 180.

The housing 100 includes an opening portion, and the first polarizing plate 120 and the liquid crystal display panel 110 are disposed adjacent to the opening portion. The object OB is disposed at a rear of the liquid crystal display panel 110. The second polarizing plate 130 and the reflective plate 140 are disposed adjacent to a rear sidewall of the housing 100, which faces the opening portion. The light source 150 is disposed above the object OB.

According to the exemplary embodiment, the backlight unit 180 may be disposed between the second polarizing plate 130 and the reflective plate 140.

The backlight unit 180 includes an auxiliary light source 182 generating and providing a light to the liquid crystal display panel 110 and a transparent light guide plate 184 guiding the light emitted from the auxiliary light source 182.

When the backlight unit 180 is further disposed in the transparent display apparatus, an amount of the light traveling to the second polarizing plate 130 increases, thereby effectively displaying the image on the liquid crystal display panel 110.

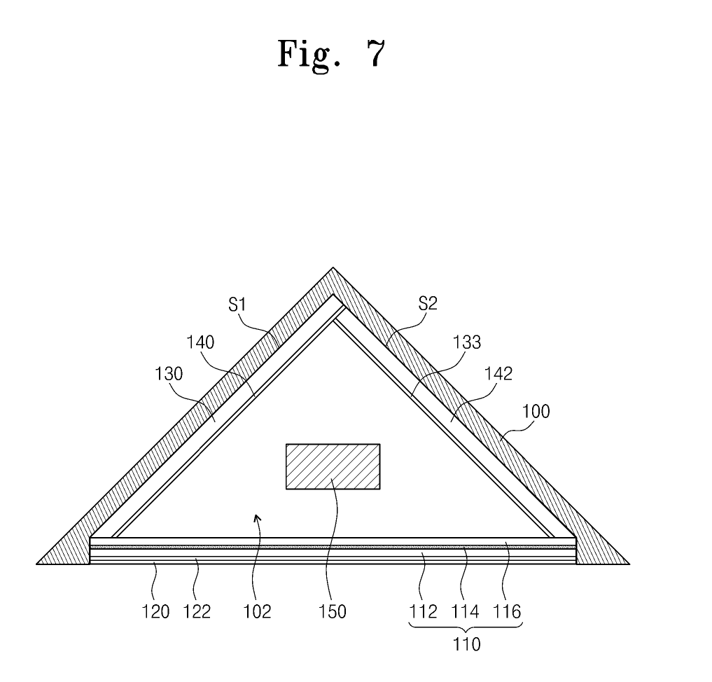

FIG. 7 is a plan cross-sectional view showing still another exemplary embodiment of a transparent display apparatus according to the invention. In FIG. 7, the same reference numerals denote the same elements in FIGS. 1 and 2, and thus detailed descriptions of the same elements will be omitted.

Referring to FIG. 7, a transparent display apparatus includes a housing 100, a liquid crystal display panel 110, a first polarizing plate 120, a second polarizing plate 130, a third polarizing plate 133, a first reflective plate 140, a second reflective plate 142 and a light source 150.

The housing 100 defines a display space 102 in which the object OB is accommodated. The housing 100 includes an opening portion where a surface or side thereof is absent and at least one sidewall surrounding the object OB. In addition, the housing 100 may further include an upper surface and a lower surface, which are substantially vertical (e.g., perpendicular) to the surface and the sidewall.

As shown in FIG. 7, the housing 100 may have a triangular shape when viewed in a plan cross-sectional view substantially parallel to the upper surface thereof. In this case, the housing 100 includes two sidewalls. For the convenience of explanation, the two sidewalls will be referred to as a first sidewall S1 and a second sidewall S2, respectively.

The first polarizing plate 120 and the liquid crystal display panel 110 are disposed adjacent to the opening portion of the housing 100. The second polarizing plate 130 and the first reflective plate 140 are disposed on the first sidewall S1, and the third polarizing plate 133 and the second reflective plate 142 are disposed on the second sidewall S2. In the exemplary embodiment, the first polarizing plate 120 has a first polarizing axis, and the second and third polarizing plates 130 and 132 have a second polarizing axis different from the first polarizing axis. The first and second polarizing axes may be substantially perpendicular to each other.

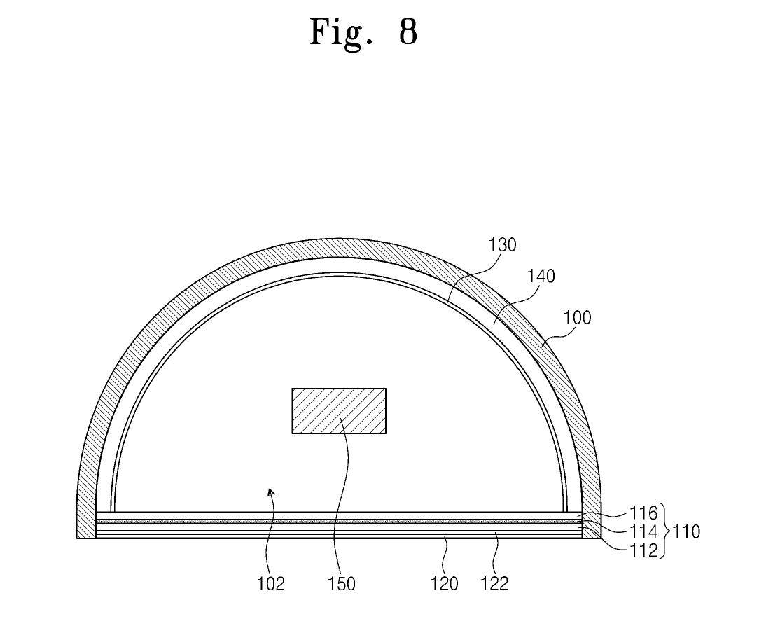

FIG. 8 is a plan cross-sectional view showing still another exemplary embodiment of a transparent display apparatus according to the invention. In FIG. 8, the same reference numerals denote the same elements in FIGS. 1 and 2, and thus detailed descriptions of the same elements will be omitted.

Referring to FIG. 8, a transparent display apparatus includes a housing 100, a liquid crystal display panel 110, a first polarizing plate 120, a second polarizing plate 130, a reflective plate 140 and a light source 150.

The housing 100 defines a display space 102 in which the object OB is accommodated. The housing 100 includes an opening portion where a surface or side thereof is absent and at least one sidewall surrounding the object OB. In addition, the housing 100 may further include an upper surface and a lower surface, which are substantially vertical (e.g., perpendicular) to the surface and the sidewall.

As shown in FIG. 8, the housing 100 has a semi-circular shape when viewed in a plan cross-sectional view substantially parallel to the upper surface thereof. In this case, the housing 100 includes one sidewall and the sidewall is a curved shape.

The first polarizing plate 120 and the liquid crystal display panel 110 are disposed adjacent to the opening portion of the housing 100. The second polarizing plate 130 and the reflective plate 140 are disposed on the one curved sidewall of the housing 100. According to the exemplary embodiment, the second polarizing plate 130 and the reflective plate 140 may have a curved shape corresponding to the shape of the curved sidewall of the housing 100.

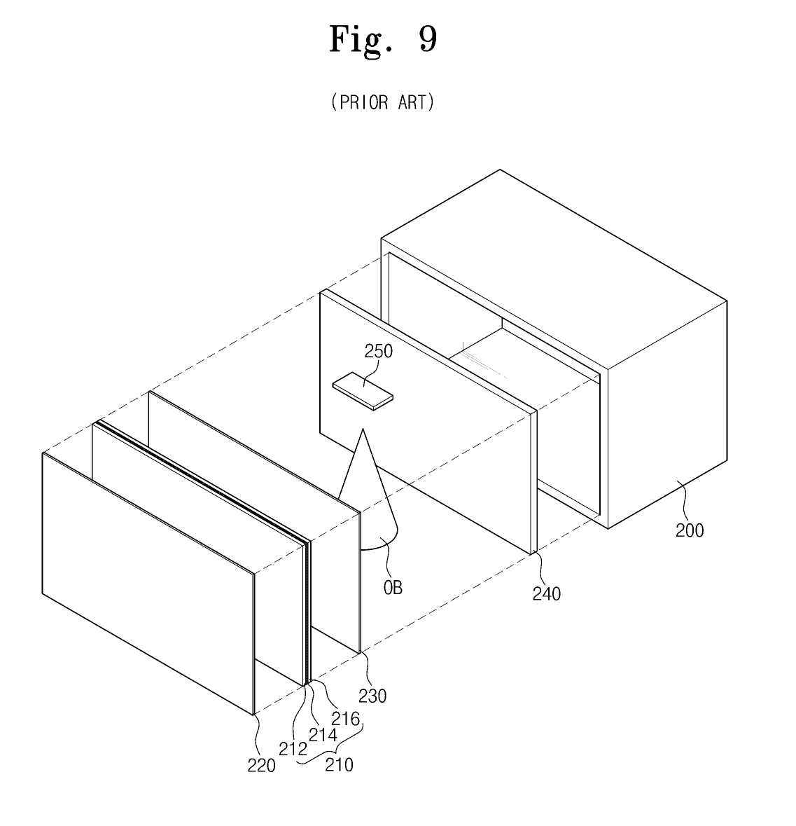

FIG. 9 is an exploded perspective view showing a conventional transparent display apparatus.

Referring to FIG. 9, a conventional transparent display apparatus includes a housing 200, a liquid crystal display panel 210, a first polarizing plate 220, a second polarizing plate 230, a reflective plate 240 and a light source 250. The liquid crystal display panel 210 includes a first substrate 212, a second substrate 216 facing the first substrate 212, and a liquid crystal layer 214 disposed between the first substrate 212 and the second substrate 216.

The housing 200 includes an opening portion where a surface is absent and defines a display space in which the object OB is accommodated. The liquid crystal display panel 210 is disposed adjacent to the opening portion of the housing 200. The first and second polarizing plates 220 and 230 are disposed at a rear and a front of the liquid crystal display panel 210, respectively. The object OB is disposed at a rear of the second polarizing plate 230, and the reflective plate 240 is disposed on a rear sidewall of the housing 100, which is disposed at a rear of the object OB.

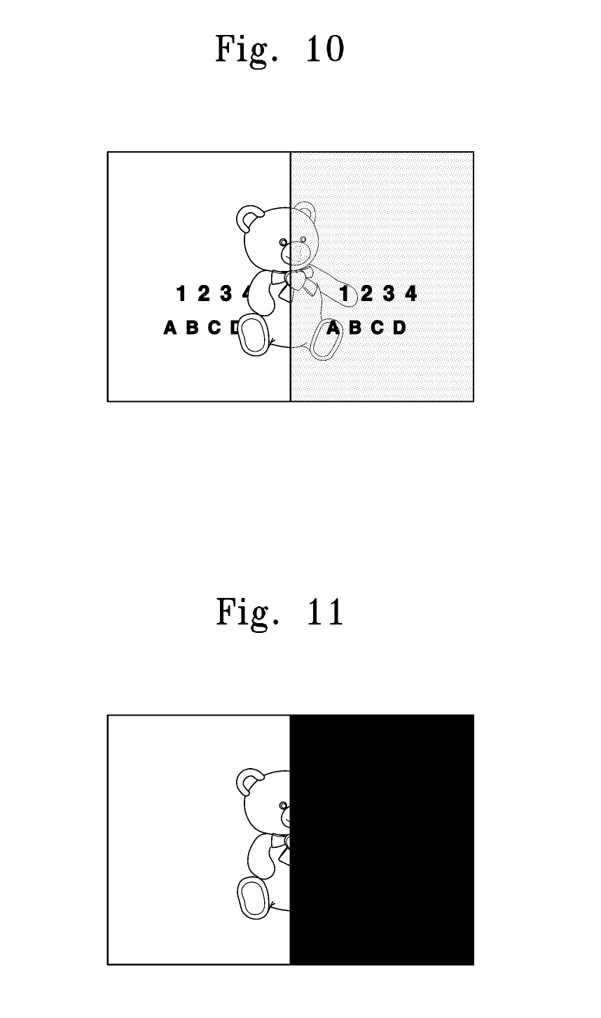

FIG. 10 is a view showing an exemplary embodiment of a displayed object and a displayed image by a transparent display apparatus according to the invention, and by a conventional transparent display apparatus.

The object and the image obtained by using the transparent display apparatus shown in FIGS. 1 and 2 have been shown in a left portion in FIG. 10, and the object and the image obtained by using the conventional transparent display apparatus shown in FIG. 9 have been shown in a right portion in FIG. 10.

As shown in FIG. 10, the image is overlapped with the object in the left portion, so that a visibility of the object may be improved. In addition, the second polarizing plate is disposed at the rear of the object, and thus the amount of the light is enhanced, thereby improving the vividness of the object.

FIG. 11 is a view showing states when no power source is applied to an exemplary embodiment of a transparent display apparatus according to the invention, and to a conventional transparent display apparatus.

In FIG. 11, a left portion represents the transparent display apparatus described with reference to FIGS. 1 and 2 and a right portion represents the conventional transparent display apparatus described with reference to FIG. 9. When the power source is not applied to the exemplary embodiment of the transparent display apparatus according to the invention and is not applied to the conventional transparent display apparatus, the conventional transparent display apparatus is in a black mode, and thus the object may be not perceived to the users. However, although the exemplary embodiment of the transparent display apparatus according to the invention is in the black mode, the object may be continuously perceived to the users since the second polarizing plate is disposed at the rear of the object.

Thus, although the power source is not applied, the object is continuously perceived in the transparent display apparatus, thereby effectively displaying the object. In addition, the display of the object may be continuously maintained even though the liquid crystal display panel is malfunctioned.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A transparent display apparatus comprising:
a housing including an opening portion which extends through a surface at a viewing side thereof, wherein the housing accommodates an object;
a liquid crystal display panel at a viewing side of the object and adjacent to the opening portion;
a first polarizing plate between the opening portion and the liquid crystal display panel;
a second polarizing plate at a rear opposing the viewing side of the object;
a first reflective plate at a rear of the second polarizing plate; and
a light source adjacent to the object.

2. The transparent display apparatus of claim 1, wherein the first polarizing plate has a first polarizing axis, and the second polarizing plate has a second polarizing axis substantially perpendicular to the first polarizing axis.

3. The transparent display apparatus of claim 1, wherein the housing further comprises a sidewall portion which extends from the surface including the opening portion, wherein the sidewall portion and the surface including the opening portion define a display space in which the object is accommodated.

4. The transparent display apparatus of claim 3, wherein the housing has a polygonal shape or a semi-circular shape in a cross-sectional view substantially perpendicular to the sidewall portion.

5. The transparent display apparatus of claim 3, further comprising a third polarizing plate and a second reflective plate,
wherein
the sidewall portion includes a plurality of sidewalls, and
the third polarizing plate and the second reflective plate are on at least one of the plurality of sidewalls.

6. The transparent display apparatus of claim 1, further comprising a backlight unit between the liquid crystal display panel and the object,
wherein the backlight unit comprises:
an auxiliary light source at an edge of the liquid crystal display panel, wherein the auxiliary light source generates and emits a light;
a transparent light guide plate which guides the light emitted from the auxiliary light source to the liquid crystal display panel; and
a third polarizing plate between the auxiliary light source and the transparent light guide plate.

7. The transparent display apparatus of claim 6, wherein the third polarizing plate has a polarizing axis substantially perpendicular to a polarizing axis of the first polarizing plate.

8. The transparent display apparatus of claim 1, further comprising a backlight unit between the second polarizing plate and the first reflective plate,
wherein the backlight unit comprises:
an auxiliary light source at an edge of the second polarizing plate, wherein the auxiliary light source generates and emits a light; and
a transparent light guide plate which guides the light emitted from the auxiliary light source to the second polarizing plate.

9. The transparent display apparatus of claim 1, wherein the second polarizing plate contacts the first reflective plate.

10. The transparent display apparatus of claim 1, further comprising optical sheets between the second polarizing plate and the first reflective plate.

11. The transparent display apparatus of claim 10, wherein the optical sheets comprise at least one of a brightness enhancement film, a dual brightness enhancement film, a diffusion sheet, a prism sheet or a protective sheet.

12. The transparent display apparatus of claim 1, further comprising a transparent retardation film between the first polarizing plate and the liquid crystal display panel.

13. A method of forming a transparent display apparatus, the method comprising:
disposing an object in a display area of a housing, the housing including an opening which extends through a surface thereof at a viewing side of the transparent display apparatus, and a sidewall portion extending from the surface, wherein the surface including the opening and the sidewall portion define the display area;
disposing a liquid crystal display panel adjacent to the opening portion;
disposing a first polarizing plate at a viewing side of the liquid crystal display panel;
disposing a second polarizing plate between the object and the sidewall portion of the housing, the object between the first and second polarizing plates;
disposing a reflective plate between the second polarizing plate and the sidewall portion of the housing; and
disposing a light source adjacent to the object.

14. The method of claim 13, wherein the first polarizing plate has a first polarizing axis, and the second polarizing plate has a second polarizing axis substantially perpendicular to the first polarizing axis.

15. The method of claim 13, wherein the sidewall portion is a single sidewall which is curved and extends from both of opposing ends of the surface of the housing including the opening.

16. The method of claim 13, wherein the sidewall portion is a plurality of sidewalls which form a triangular shape with the surface of the housing including the opening.

17. The method of claim 13, wherein the light source overlaps the object in a cross-sectional view substantially perpendicular to the sidewall portion.

18. The method of claim 13, further comprising disposing a backlight unit between the liquid crystal display panel and the object,
wherein the backlight unit comprises:
an auxiliary light source at an edge of the liquid crystal display panel, wherein the auxiliary light source generates and emits a light;
a transparent light guide plate which guides the light emitted from the auxiliary light source to the liquid crystal display panel; and
a third polarizing plate between the auxiliary light source and the transparent light guide plate, wherein the third polarizing plate has a polarizing axis substantially perpendicular to a polarizing axis of the first polarizing plate.

19. The method of claim 13, further comprising disposing a backlight unit between the second polarizing plate and the reflective plate,
wherein the backlight unit comprises:
an auxiliary light source at an edge of the second polarizing plate, wherein the auxiliary light source generates and emits a light; and
a transparent light guide plate which guides the light emitted from the auxiliary light source to the second polarizing plate.
